(19) United States
(12) Patent Application Publication
(10) Pub. No.: US 2024/0019638 A1
(43) Pub. Date: Jan. 18, 2024

(54) OPTICAL INTERCONNECT FOR EDGE COUPLING

(71) Applicant: 3M INNOVATIVE PROPERTIES COMPANY, St. Paul, MN (US)

(72) Inventors: Michael A. Haase, St. Paul, MN (US); David B. Stegall, St. Paul, MN (US)

(21) Appl. No.: 18/030,573

(22) PCT Filed: Sep. 21, 2021
(86) PCT No.: PCT/IB2021/058599

§ 371 Date: Apr. 6, 2023

Related U.S. Application Data
(60) Provisional application No. 63/093,984, filed on Oct. 20, 2020.

(51) Int. Cl. G02B 6/30

(52) U.S. Cl. CPC G02B 6/30

(57) ABSTRACT

An optical assembly includes a substrate with a plurality of optical waveguides, and a unitary optics array assembled to the substrate. The unitary optics array includes a support portion attached to the substrate, an input surface facing a first waveguide end of each optical waveguide, a redirecting surface, and an output surface. For each optical waveguide, the input surface is configured to receive and transmit a central light ray propagating through and emitted from the first waveguide end of the optical waveguide, and the redirecting surface is configured to receive the central light ray transmitted by the input surface along a first direction and redirect the received central light ray along a second direction different from the first direction, the redirected central light ray exiting the optics array as an output central light ray through the output surface.

### SUMMARY

In some aspects of the present description, an optical assembly is provided, the optical assembly including a substrate with a plurality of optical waveguides, each optical waveguide having a first waveguide end, and a unitary optics array assembled to the substrate. The unitary optics array includes a support portion attached to the substrate and covering at least a portion of a major top surface of the substrate, an input surface facing the first waveguide end of each optical waveguide, a redirecting surface, and an output surface. For each optical waveguide in the plurality of optical waveguides, the input surface is configured to receive and transmit a central light ray propagating through and emitted from the first waveguide end of the optical waveguide, and the redirecting surface is configured to receive the central light ray transmitted by the input surface along a first direction and redirect the received central light ray along a second direction different from the first direction, the redirected central light ray exiting the optics array as an output central light ray through the output surface.

In some aspects of the present description, a substrate is provided, the substrate defining a recess therein, the recess configured to receive therein, and permanently bond to, at least a portion of an optics array, and at least one optical waveguide formed on or in the substrate and terminating at the recess.

In some aspects of the present description, an optical assembly is provided, the optical assembly including a substrate with opposing major surfaces and a minor surface extending along at least a portion of a thickness of the substrate, at least one first optical waveguide integrally formed on or in the substrate and terminating at the minor surface, and a unitary optics array and a unitary optical ferrule assembled to each other and to the substrate. Each of the optics array and the optical ferrule are configured to receive a central light ray emitted by an optical waveguide from an input surface thereof along an input direction and transmit the received central light ray through an output surface thereof along a different output direction. At least a portion of the input surface of the optics array is disposed proximate to, and facing, the minor surface. The optics array and the optical ferrule, in combination, are configured to receive light from the at least one first optical waveguide and transmit the received light to a second optical waveguide attached to the optical ferrule.

In some aspects of the present description, an optical assembly is provided, the optical assembly including a substrate having a major surface and a minor surface intersecting the major surface, at least one first optical waveguide integrally formed on or in the substrate and having a first waveguide end at the minor surface, a unitary optics array attached to the major surface, a unitary optical ferrule assembled to the optics array, and at least one second optical waveguide including a second waveguide end attached to the optical ferrule. The optical assembly is configured to transfer light between the first and second waveguide ends through the optics array and the optical ferrule.

In some aspects of the present description, a unitary optics array is provided, the unitary optics array configured for transferring light between at least one first optical waveguide integrally formed on or in a substrate and terminated at a minor surface of the substrate and at least one second optical waveguide attached to an optical ferrule. The unitary optics array includes a support surface, an input surface, a light redirecting surface, and an output surface. When the unitary optics array is assembled to the substrate and the optical ferrule so that the support surface is disposed on and covers at least a portion of a major surface of the substrate, the input surface faces the first waveguide end of the at least one first optical waveguide, and the output surface faces an input surface of the optical ferrule, a central light ray emitted by the at least one first optical waveguide couples to the at least one second optical waveguide after entering the unitary optics array through the input surface, changing direction by being redirected by the light redirecting surface, and exiting the unitary optics array through the output surface.

In some aspects of the present description, an optical waveguide assembly is provided, the optical waveguide assembly including a substrate defining a recess therein, the recess comprising a wall substantially orthogonal to a major surface of the substrate and disposed within, and away from, an outermost perimeter of the substrate, and a plurality of optical waveguides disposed on or in the substrate. Each optical waveguide includes a first waveguide end disposed at the wall of the recess, wherein a central light ray emitted by the optical waveguide propagates along a direction making an oblique angle with the wall of the recess.

### BRIEF DESCRIPTION OF THE DRAWINGS

FIGS. 1A and 1B provide perspective views of an optical assembly, in accordance with an embodiment of the present description;

FIGS. 2A and 2B provide perspective views of a unitary optics array in relation to a substrate, in accordance with an embodiment of the present description;

FIGS. 3A-3C provide perspective views of a unitary optics array, in accordance with an embodiment of the present description;

FIG. 4 provides a perspective views of a unitary optics array assembled to optical waveguides on a substrate, in accordance with an embodiment of the present description;

FIGS. 5A-5C provide perspective views of a unitary optics array, in accordance with an alternate embodiment of the present description;

FIGS. 6A and 6B provide side and perspective views, respectively, of a unitary optics array assembled to optical waveguides on a substrate, in accordance with an embodiment of the present description;

FIG. 7 provides a side view of a unitary optics array assembled to optical waveguides on a substrate, in accordance with an alternate embodiment of the present description;

FIGS. 8A and 8B provide perspective views of a unitary optics array assembled to optical waveguides on a substrate, in accordance with an alternate embodiment of the present description;

FIGS. 9A and 9B provide perspective views of an optical waveguide on a substate, in accordance with an embodiment of the present description;

FIGS. 10A-10E provide views of an optical waveguide on a substate, in accordance with an embodiment of the present description;

FIGS. 11A and 11B provide cutaway, perspective views of a unitary optics array assembled to optical waveguides on a substrate, in accordance with an embodiment of the present description;

FIGS. 12A and 12B provide exploded perspective views of a unitary optics array interfacing to an optical waveguide within a recess within a substrate, in accordance with an alternate embodiment of the present description;

FIGS. 13A and 13B provide exploded perspective views of a unitary optics array interfacing to an optical waveguide at the edge of a substrate, in accordance with an embodiment of the present description;

FIGS. 14A and 14B provide exploded perspective views of a unitary optics array interfacing to a unitary optical ferrule, in accordance with an embodiment of the present description; and

FIG. 15 provides a cutaway side view of the path of a central light ray through an optical assembly, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

The demand for high-bandwidth optical interconnects for the data communication market is increasing rapidly. Optical interconnects for silicon photonics will soon surpass conventional copper-based technology as the preferred method to provide input/output data ports into high bandwidth optical systems. There are two dominant methods for connecting the photonic integrated circuit (PIC) waveguide mode with an optical fiber: grating-based surface emitting waveguide couplers and direct end-fire or edge coupling between the waveguide and optical fiber.

While grating-based surface emitting waveguide couplers have seen more widespread implementation, they suffer from wavelength-sensitivity and high losses. By contrast, direct edge coupling between the waveguide and optical fiber may be relatively wavelength-insensitive and compatible with an anticipated growth of high bandwidth wavelength multiplexing architectures.

However, a major obstacle to the use of edge couplers is that PIC single-mode waveguides typically have cross-sections with sub-micron dimensions, whereas commercial single-mode optical fibers exhibit mode diameters on the order of 10 microns. The mode spot size mismatch can lead to intolerable optical losses. There exist many examples of integrating mode spot size converters onto the PIC, but these solutions are typically not manufacturable by PIC foundries and often suffer from other problems like high loss and polarization-sensitivity. While foundry-acceptable integrated solutions do exist for effectively converting the small silicon waveguide mode with a sub-micron spot diameter into a spot of a few square microns, the technique typically involves fabricating a lateral inverse taper in the silicon waveguide followed by an overlay of a lower refractive index material. The overlay preferably consists of silicon nitride or silicon oxynitride due to compatibility with CMOS processing. Due to mechanical stresses created between silicon nitride and the PIC, creating an overlay thickness for generating a spot diameter larger than 3 microns is difficult. There are examples of the integrated silicon waveguide taper being overlaid with an even lower refractive index polymer to expand the beam more, but the anticipated high temperatures involved with solder reflow during module assembly and the expected module operational temperatures exceed the tolerance of almost any polymer. These integrated solutions also do not address the desire for interconnects to be pluggable and separable, which would provide an economic modularity to the assembly and packaging of silicon photonics modules.

According to some aspects of the present invention, an optical assembly providing an expanded-beam, single-mode interconnect solution is described to address these problems. In some embodiments, an optical assembly may include a substrate with a plurality of optical waveguides, each optical waveguide having a first waveguide end, and a unitary optics array assembled to the substrate. The unitary optics array may include a support portion attached to the substrate and covering at least a portion of a major top surface of the substrate, an input surface facing the first waveguide end of each optical waveguide, a redirecting surface, and an output surface. In some embodiments, for each optical waveguide in the plurality of optical waveguides, the input surface may be configured to receive and transmit a central light ray (e.g., a chief light ray) propagating through and emitted from the first waveguide end of the optical waveguide, and the redirecting surface may be configured to receive the central light ray transmitted by the input surface along a first direction and redirect the received central light ray along a second direction different from the first direction, such that the redirected central light ray exits the optics array as an output central light ray through the output surface. In some embodiments, the redirecting surface redirects and optionally focuses (e.g., collimates) the central light ray received from the input surface via total internal reflection.

In some embodiments, the support portion of the unitary optics array may cover at least a portion of at least one of the plurality of optical waveguides of the substrate, or at least a portion of each of the plurality of optical waveguides. In some embodiments, the at least a portion of the top surface of the substrate covered by the support portion of the optics array includes at least portions of the plurality of optical waveguides. In some embodiments, the portion of the major top surface covered by the support portion of the unitary optics array may be on a lateral side of the plurality of optical waveguides (e.g., an area adjacent to the optical waveguides). In some embodiments, the support portion may not cover one or more of the optical waveguides. In some embodiments, the support portion may cover an exposed end of one or more of the optical waveguides, but not the portions of the optical waveguides parallel to the substrate (i.e., the support portion may cover an exposed end of an optical waveguide, but may not extend over the length of the optical waveguides running parallel to the major top surface of the substrate.)

In some embodiments, at least one of the plurality of optical waveguides may be a ridge waveguide (i.e., the waveguide protrudes from the major top surface of the substrate). In some embodiments, the support portion of the unitary optics array may include at least one groove or extended channel configured to receive at least a portion of the ridge waveguide.

In some embodiments, the substrate may include a minor surface extending from the major top surface of the substrate along a thickness direction (i.e., an edge surface of the substrate, substantially orthogonal to the plane of the major top surface). In some embodiments, the first waveguide ends may be disposed adjacent to the minor surface (i.e., the first waveguide ends may be disposed near and substantially parallel to the minor surface). In some embodiments, the first waveguide ends may be substantially flush with the minor surface. In some embodiments, the first waveguide ends may be recessed from or protruding from the minor surface. In some embodiments, the minor surface may be stepped such that a first portion of the minor surface extends farther in a lateral direction of the substrate (i.e., parallel to the plane of the major top surface) than a second portion of the minor surface, creating a stepped edge down from the major top surface. In some embodiments, the first waveguide ends may be offset rearwardly from the extended first portion of the minor surface (e.g., flush with or closer to the non-extended second portion of the minor surface, or the “first step down”).

In some embodiments, the substrate may include a minor surface extending from the major top surface of the substrate along a thickness direction of the substrate, and the unitary optics array includes a stop surface disposed proximate and facing the minor surface of the substrate, and the stop surface and the input surface of the unitary optics array are offset relative to each other along lengths of the optical waveguides. Stated another way, the substrate may include a stepped side edge with a first portion and second portion of the stepped edge substantially parallel to each other but offset relative to each other along the lengths of the optical waveguides, and the unitary optics array may have an inverse, complimentary stepped edge where the input surface and the stop surface are offset relative to each other, such that, when the unitary optics array is mated to the stepped side edge of the substrate, the input surface of the unitary optics array is near to and parallel to the second (non-extended) portion (the “top step”) of the stepped side edge, and the stop surface is near to and parallel to the first (extended) portion (the “bottom step”) of the stepped side edge. Stated another way, the offset between the stop surface and the input surface of the unitary optics array defines a shoulder portion of the unitary optics array, and the minor surface of the substrate (including the first and second portion of the minor surface) defines a cutout therein which receives and supports the shoulder portion of the unitary optics array when properly mated. In other embodiments, the first waveguide ends of the optical waveguides and the input surface of the unitary optics array define a reservoir therebetween configured to be substantially filled with an optical material (e.g., an optical adhesive).

In some embodiments, the support portion of the unitary optics array and the major top surface of the substrate covered by the support portion define a gap therebetween that extends laterally across the plurality of optical waveguides. In some embodiments, the support portion of the unitary optics array includes a pair of opposing shoulders extending from a bottom surface of the support portion. In some embodiments, the shoulders define a recessed portion therebetween, each shoulder resting on the major top surface of the substrate on a corresponding lateral side of the plurality of optical waveguides.

In some embodiments, the substrate may have opposing first and second major surfaces (e.g., the major top surface and an opposing major bottom surface), and an outermost minor surface (edge) connecting the first and second major surfaces and defining an outermost perimeter of the substate. In some embodiments, the substrate may also have an inner minor surface disposed within, and away from, the outermost parameter, wherein the first waveguide end of each optical waveguide is disposed at the inner minor surface. Stated another way, the inner minor surface defines an edge of a cutout in the substrate, and the first waveguide ends at and/or adjacent to the inner minor surface (i.e., capable of emitting light into, or receiving light from within, the inside of the cutout). In some embodiments, the substrate defines a recess in the first major surface, the recess including the inner minor surface, and at least a portion of the input surface of the unitary optics array is disposed within the recess proximate to, and facing, the first waveguide ends and the inner minor surface. In some embodiments, the recess is a through recess extending across the entire thickness of the substrate and connecting the first and second major surfaces. In some embodiments, the inner minor surface and the input surface of the unitary optics array are substantially parallel to each other.

In some embodiments, the substrate may have opposing first and second major surfaces (e.g., the major top surface and an opposing major bottom surface), and an outermost minor surface (edge) connecting the first and second major surfaces and defining an outermost perimeter of the substate, and the first waveguide edge of each optical waveguide is disposed at the outermost minor surface, and at least a portion of the input surface of the unitary optics array is disposed proximate to, and facing, the first waveguide end and the outermost minor surface. In some embodiments, the outermost minor surface and the input surface of the unitary optics array are substantially parallel to each other.

In some embodiments, for at least one wavelength from about 450 nm to about 2000 nm, the optics array has an index of refraction between about 1.4 and about 2.3. In some embodiments, the optics array includes one or more of a polymer, a ceramic, a glass, an alumina, a fused silica, a titania, and a zirconia.

In some embodiments, the substrate may include a minor side surface extending downwardly from a first edge of the major top surface of the substrate along a thickness direction of the substrate, and the substrate defines a cutout at the first edge. In some embodiments the cutout has an open top at the major top surface, an open side at the minor side surface, and a back wall offset rearwardly from, and making an oblique angle with, the minor surface. In some embodiments, the first waveguide end of at least one of the plurality of optical waveguides is disposed at the back wall of the cutout. In some embodiments, the at least one optical waveguide includes at least one bend that changes a direction of propagation of a central light ray propagating in and along the at least one optical waveguide. In some embodiments, a central light ray emitted by the at least one optical waveguide propagates along a direction substantially perpendicular to the minor side surface of the substrate.

According to some aspects of the present description, a substrate includes and defines a recess therein, the recess configured to receive therein, and permanently bond to, at least a portion of an optics array, and at least one optical waveguide formed on or in the substrate and terminating at the recess. In some embodiments, the at least one optical waveguide may be a plurality of optical waveguides. In some embodiments, the recess may be within and away from an outermost perimeter of the substrate (e.g., a pit in the substrate surface). In some embodiments, the recess may extend only partially through the thickness of the substrate. In other embodiments, the recess may be a through-recess (e.g., a through-hole) connecting opposing top and bottom major surfaces of the substrate. In some embodiments, the recess may extend to the outermost minor surface (i.e., outermost edge) of the substrate, so as to have an open side at the outermost minor surface (e.g., an open notch at an edge of the substrate).

According to some aspects of the present description, an optical assembly may include a substrate with opposing major surfaces (e.g., top and bottom surfaces) and a minor surface extending along at least a portion of a thickness of the substrate (e.g., an outer edge), at least one first optical waveguide integrally formed on or in the substrate and terminating at the minor surface (e.g., terminating at an outer edge of the substrate), and a unitary optics array and a unitary optical ferrule assembled to each other and to the substrate. Each of the optics array and the optical ferrule are configured to receive a central light ray (e.g., a chief light ray) emitted by an optical waveguide from an input surface thereof along an input direction and transmit the received central light ray through an output surface thereof along a different output direction. At least a portion of the input surface of the optics array is disposed proximate to, and facing, the minor surface. The optics array and the optical ferrule, in combination, are configured to receive light from the at least one first optical waveguide and transmit the received light to a second optical waveguide attached to the optical ferrule. In some embodiments, the unitary optics array may be permanently assembled to the substrate and the optical ferrule may be removably assembled to the unitary optics array (e.g., mechanically connected with engaging features between the optical ferrule and the optics array, but not bonded).

According to some aspects of the present description, an optical assembly includes a substrate having a major surface (e.g., a “top” substrate surface) and a minor surface (e.g., a side edge) intersecting the major surface, at least one first optical waveguide integrally formed on or in the substrate and having a first waveguide end at the minor surface, a unitary optics array attached to the major surface, a unitary optical ferrule assembled to the optics array, and at least one second optical waveguide including a second waveguide end attached to the optical ferrule. In some embodiments, the optical assembly may be configured to transfer light between the first and second waveguide ends through the optics array and the optical ferrule. In some embodiments, the optical ferrule may be removably assembled (e.g., temporarily attached or engaged) to the optics array.

According to some aspects of the present description, a unitary optics array may be configured for transferring light between at least one first optical waveguide integrally formed on or in a substrate and terminated at a minor surface (e.g., an outer edge) of the substrate and at least one second optical waveguide attached to an optical ferrule. In some embodiments, the unitary optics array may include a support surface, an input surface, a light redirecting surface, and an output surface. In some embodiments, when the unitary optics array is assembled to the substrate and the optical ferrule so that the support surface is disposed on and covers at least a portion of a major surface of the substrate, the input surface faces the first waveguide end of the at least one first optical waveguide, and the output surface faces an input surface of the optical ferrule, a central light ray (e.g., a chief light ray) emitted by the at least one first optical waveguide may couple to the at least one second optical waveguide after entering the unitary optics array through the input surface, changing direction by being redirected by the light redirecting surface, and exiting the unitary optics array through the output surface. In some embodiments, the support surface and the output surface may be substantially parallel to each other.

According to some aspects of the present description, an optical waveguide assembly may include a substrate defining a recess therein, the recess comprising a wall (e.g., an inner “edge”) substantially orthogonal to a major surface of the substrate and disposed within, and away from, an outermost perimeter of the substrate (i.e., a recess in the interior of the substrate, away from the outer edge of the substrate), and an optical waveguide disposed on or in the substrate. The optical waveguide may include a first waveguide end disposed at the wall of the recess, wherein a central light ray (e.g., a chief light ray) emitted by the optical waveguide may propagate along a direction making an oblique angle with the wall of the recess. In some embodiments, the recess may include an open side at a minor side surface of the substrate disposed at the outermost perimeter of the substrate (e.g., a “notch” disposed at the outer edge of the substrate), and wherein the direction of propagation of the central light ray emitted by the optical waveguide may be substantially perpendicular to the minor side surface. In some embodiments, the optical waveguide assembly may include a substrate with a plurality of recesses and a plurality of optical waveguides. In such embodiments, the first waveguide end of each of the plurality of waveguides may be disposed at the wall of a different one of the plurality of recesses.

According to some aspects of the present description, an optical waveguide assembly may include a substrate defining a plurality of recesses therein, each recess of the plurality of recesses having a wall substantially orthogonal to a major surface of the substrate and disposed within, and away from, an outermost perimeter of the substrate, and a plurality of optical waveguides disposed on or in the substrate. In some embodiments, each optical waveguide may include a first waveguide end disposed at the wall of a corresponding recess of the plurality of recesses, such that a central light ray emitted by the optical waveguide propagates along a direction making an oblique angle with the wall of the recess. In some embodiments, each recess of the plurality of recesses includes an open side at a minor side surface of the substrate disposed at the outermost perimeter of the substrate, and the direction of propagation of the central light ray emitted by the optical waveguide is substantially perpendicular to the minor side surface.

In some embodiments, the first waveguide ends of the plurality of optical waveguides may define a line (i.e., a line segment connecting each of the waveguide ends) on the major surface of the substrate. In some embodiments, the direction of propagation of the central light ray emitted by each optical waveguide may be substantially perpendicular to the line. In some embodiments, the line defined by the waveguide ends may be substantially parallel to the minor side surface. In other embodiments, the line may make an oblique angle with the minor side surface.

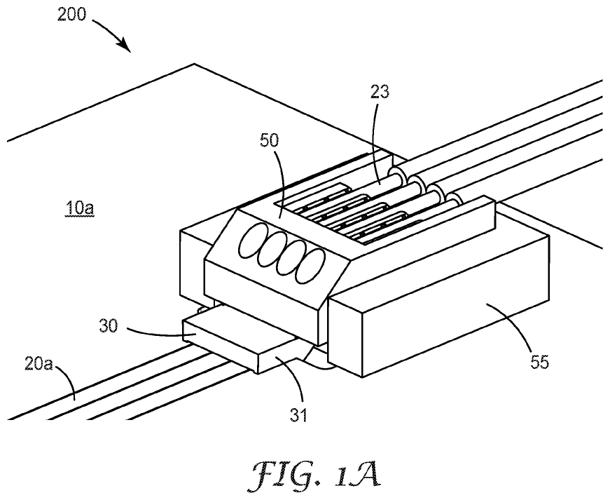

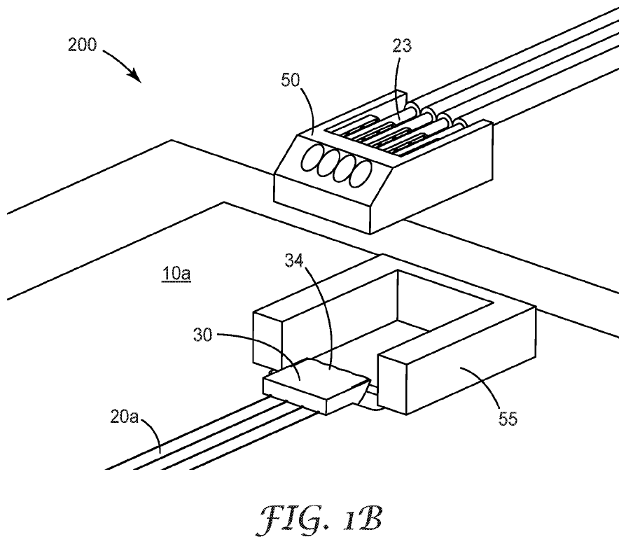

Turning now to the figures, FIGS. 1A and 1B provide perspective views of an optical assembly according to the present description and should be viewed together for the following discussion. FIG. 1A provides an assembled perspective view of the optical assembly (components in a mated configuration) and FIG. 1B provides an unassembled perspective view (some of the components in an unmated configuration). In the embodiment of FIGS. 1A and 1B, optical assembly 200 includes a substrate 10a (e.g., a photonic integrated circuit, or PIC), one or more optical waveguides 20a integrally formed on or in the substrate 10a, a unitary optics array 30 disposed on or near at least a portion of optical waveguides 20a and in optical communication with at least one of the optical waveguides 20a, and a unitary optical ferrule 50. In some embodiments, optical assembly 200 may further include an optical cradle 55, configured to mate to and hold in place optical ferrule 50. In some embodiments, optical ferrule 50 may include one or more second optical waveguides 23. In some embodiments, optics array 30 may include a support portion 31 that is attached to substrate 10a. In some embodiments, support portion 31 may cover at least a portion of at least one of optical waveguides 20a. In some embodiments, optics array 30 may have an output surface 34 (FIG. 1B) that, when optical ferrule 50 is seated in optical cradle 55 (FIG. 1A) allows light to exit optics array 30 and enter into optical ferrule 50 (or vice versa).

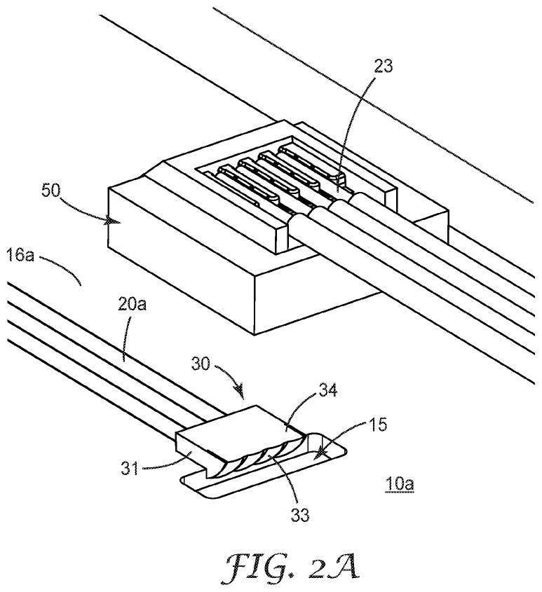

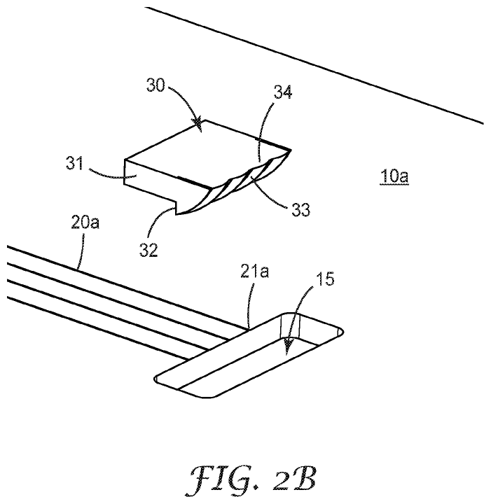

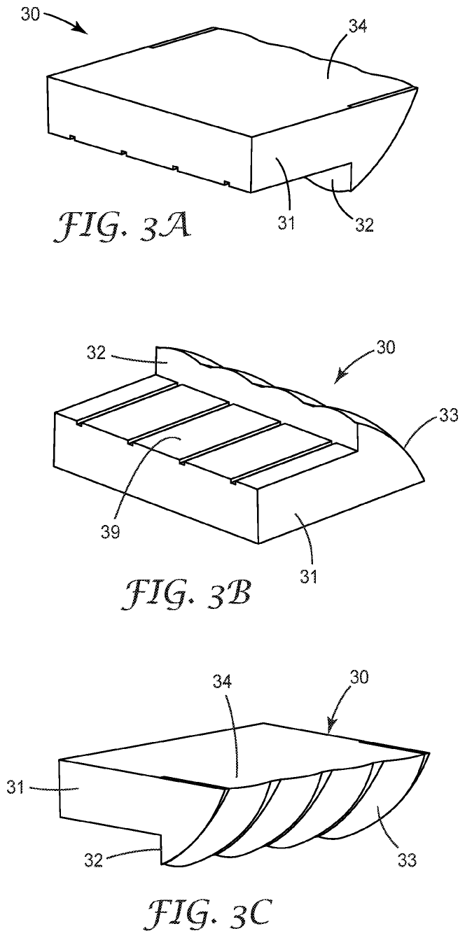

FIGS. 2A and 2B provide additional details for unitary optics array 30 as seen in FIGS. 1A-1B, and should be viewed together for the following discussion. FIG. 2A includes the unitary optical ferrule 50 (with second optical waveguides 23) in an unassembled position above output surface 34 of unitary optics array 30, showing how the pieces may be oriented with regard to each other during mating and unmating. In some embodiments, unitary optics array (or simply “optics array”) 30 may be assembled to a top major surface 16a of substrate 10a. A support portion 31 of optics array 30 may, in some embodiments, extend over top major surface 16a, which may include one or more of optical waveguides 20a embedded in or disposed on top major surface 16a. A portion of optics array 30 including input surface 32 (better shown in FIGS. 3A-3B) may extend down into a recess 15 in substrate 10a, such that input surface 32 is adjacent to a waveguide end 21a (FIG. 2B) of at least one of optical waveguides 20a, the waveguide end 21a disposed at an inside edge of recess 15. In some embodiments, recess 15 may be a through-recess disposed in the interior of substrate 10a (away from an outer edge of substrate 10a). In other embodiments, a side of recess 15 may be open and disposed at an outer edge of substrate 10a (i.e., it may be a notch disposed at the outer edge of substrate 10a).

In addition to support portion 31 and input surface 32, optics array 30 may also include a redirecting surface 33 and an output surface 34. As will be discussed in more detail elsewhere herein, elements 32, 33, and 34 define the points of an optical pathway through optics array 30, where light from optical waveguide 20a (emitted by waveguide end 21a) enters optics array 30 through input surface 32, is redirected by (possibly angled) redirecting surface 33, and emitted through output surface 34. After being emitted by output surface 34, light may enter optical ferrule 50 and enter the one or more of second optical waveguides 23 attached to optical ferrule 50 (when optical ferrule 50 is properly mated to optics array 30. In some embodiments, light may also travel in the opposite direction, from optical ferrule 50, into the output surface 34, redirected by redirecting surface 33, and exiting through input surface 32, such that it enters waveguide end 21a of optical waveguide 20a. Labels of “input surface” and “output surface” are not meant to be limiting in any way.

Additional views of one embodiment of unitary optics array 30 from various angles are given in FIGS. 3A-3C. Optics array 30 may include a support portion 31, an input surface 32, a redirecting surface 33, and an output surface 34. In some embodiments, support portion 31 may include additional features (e.g., grooves, recessed portions) allowing it to better interface to optical waveguides 20a of substrate 10a (FIGS. 2a-2B). In some embodiments, support portion 31 may be oriented differently in relation to optics array 30, allowing optics array 30 to better mate with the appropriate surfaces of a substrate. In some embodiments, one or both of the input surface 32 and the output surface 34, may have an anti-reflective coating. In some embodiments, redirecting surface 33 may include a coating to enhance reflection (e.g., a metal coating). Additional details on these features and alternate embodiments are provided elsewhere herein.

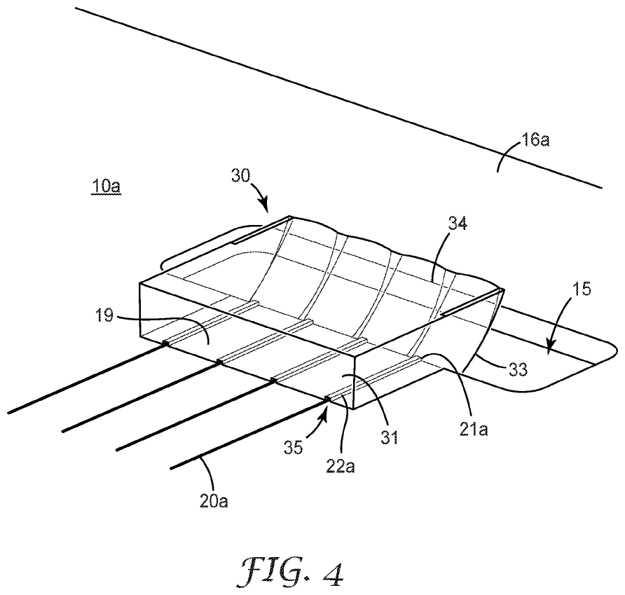

FIG. 4 provides a perspective views of a unitary optics array 30 assembled to optical waveguides 20a on a top major surface 16a of substrate 10a, showing hidden features beneath and inside optics array 30. Substrate 10a includes one or more optical waveguides 20a, each optical waveguide 20a having a waveguide end 21a disposed at an outer edge of substrate 10a, or at an inner edge of a recess 15 in a top major surface 16a of substrate 10a. A portion 19 of the major top surface 16a of substrate 10a may be covered by support portion 31 of optics array 30. In some embodiments, support portion 31 also covers at least a portion 22a of optical waveguides 20a. In some embodiments, the support portion 31 may include one or more grooves 35 configured to receive the portion 22a of optical waveguides 20a.

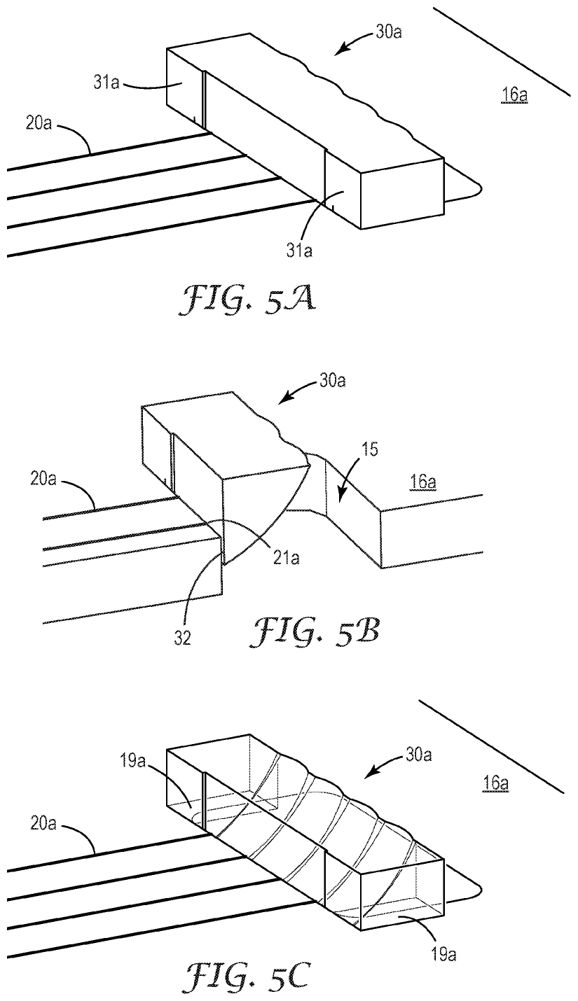

In some embodiments, optics array 30 may be disposed such that input surface 32 (FIGS. 3A-3C) of optics array 30 is adjacent to waveguide ends 21a of optical waveguides 20a. In the embodiment of FIG. 4, input surface 32 (hidden) of optics array 30 extends down into recess 15 and is substantially parallel to the inner edge of recess 15 where waveguide ends 21a are disposed. Light leaving waveguide ends 21a will travel toward redirecting surface 33 and be redirected toward output surface 34. In some embodiments, input surface 32 and/or waveguide ends 21a may have an anti-reflective coating. In some embodiments, input surface 32 and waveguide ends 21a may be bonded with an optical adhesive, and the anti-reflective coating used may be selected and/or configured to be compatible with the index of refraction of the optical adhesive. FIGS. 5A-5C provide perspective views of an alternate embodiment of a unitary optics array 30a. FIGS. 5A-5C should be viewed together for the following discussion. In the embodiments of FIGS. 5A-5C, the support portions 31a extend laterally to rest on the sides of recess 15 (on portions 19a of top major surface 16a), rather than back over optical waveguides 20a (as shown in FIG. 4). As shown in FIG. 5b , input face 32 of optics array 30a still faces and is mated to waveguide ends 21a.

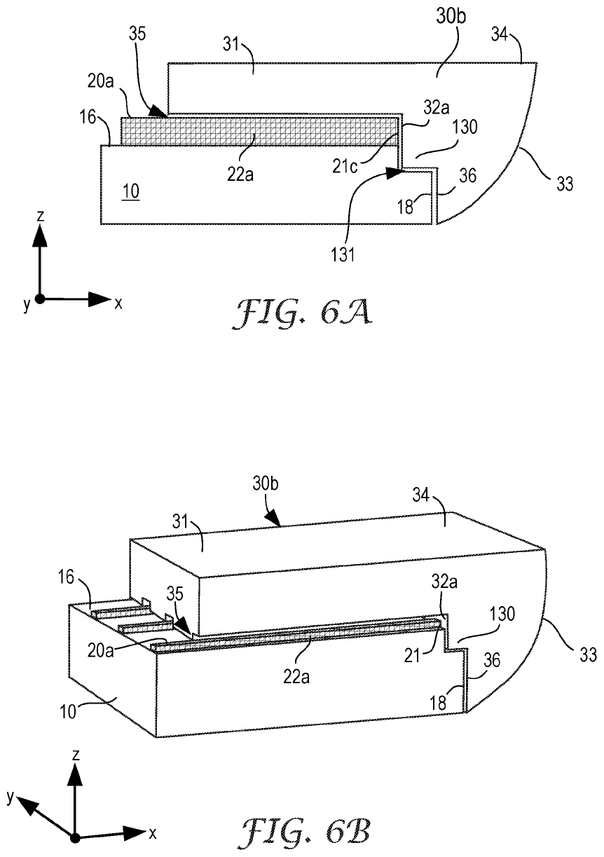

FIGS. 6A and 6B provide side and cutaway, perspective views, respectively, of another alternate embodiment of a unitary optics array 30b. Looking at FIGS. 6A and 6B together, a substrate 10 includes a minor edge surface 18 extending from a major top surface 16 of substrate 10, such that waveguide ends 21c of optical waveguides 20a are offset rearwardly from minor surface 18 along the lengths of the optical waveguides 20a (i.e., offset in the negative x direction shown in FIG. 6A). In some embodiments, this creates a “stair-step” edge for substrate 10, with minor surface 18 extending in the positive x direction past waveguide ends 21c and defining a “cutout” 131 in the edge of substrate 10. In some embodiments, mating optics array 30b may have a corresponding stair-stepped surface which includes an input surface 32a, a stop surface 36, and a shoulder portion 130 defined between input surface 32a and stop surface 36. In some embodiments, when mated, the shoulder portion 130 of optics array 30b is received by and substantially conforms to cutout 131, such that input surface 32a is adjacent waveguide ends 21c and stop surface 36 is adjacent extended minor surface 18. In some embodiments, at least a portion 22a of optical waveguides 20a may extend from major top surface 16 and may extend up into grooves 35 of support portion 31. Optics array 30b may also include redirecting surface 33 and output surface 34.

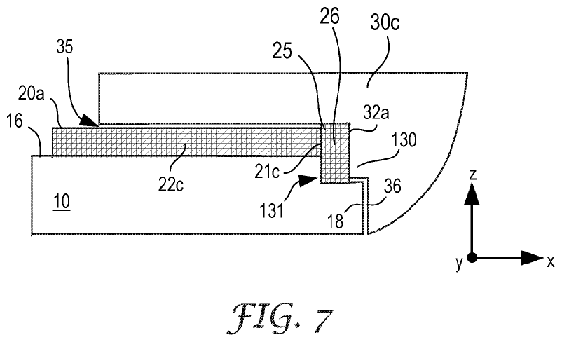

FIG. 7 provides a side view of yet another alternate embodiment of a unitary optics array 30c assembled to optical waveguides on a substrate. Reference designators common to those in FIGS. 6A-6B are used for components with similar function to those of their like-numbered components unless otherwise described herein. In this embodiment, unitary optics array 30c is configured similarly to optics array 30b of FIGS. 6A-6B, in that it features an extended minor surface 18 defining a cutout 131 in substrate 10, and waveguide ends 21c of optical waveguides 20a are offset rearwardly from the minor surface 18. In this embodiment, however, waveguide ends 21c and input surface 32a of optics array 30c define a reservoir 25 therebetween. In some embodiments, reservoir 25 may be substantially filled with an optical material 26 (e.g., an optical adhesive). In some embodiments, the input surface 32a and stop surface 36 of optics array 30c may still define a stair-step shape and shoulder portion 130, although shoulder portion 130 may be smaller than shoulder portion 130 shown in FIGS. 6A-6B. In some embodiments, there may be no shoulder portion 130 (i.e., the input surface 32a and stop surface 36 may be substantially the same surface, with no step defined therebetween).

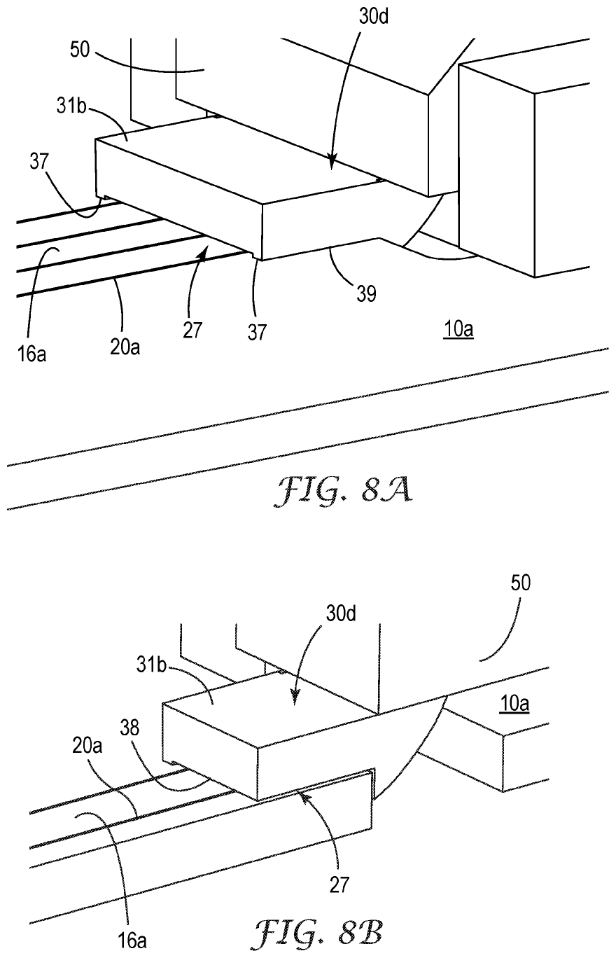

FIGS. 8A and 8B provide perspective views of another alternate embodiment of a unitary optics array 30d, and should be reviewed together for the following discussion. In some embodiments, optics array 30d is disposed on a major surface 16a of a substrate 10a. A support portion 31b of optics array 30d may extend over major surface 16a and may extend across one or more optical waveguides 20a embedded in and possibly protruding above major surface 16a(protruding as ridges above surface 16a). In some embodiments, the support portion 31b includes a support surface 39 which is disposed proximate the optical waveguides 20a when the optics array 30d is mated to the substrate 10a. In some embodiments, support surface 39 may include opposing shoulders 37 extending from and on either side of a recessed bottom surface 38, defining a gap 27 that extends laterally across the optical waveguides 20a (i.e., across the y-axis, as shown in FIG. 8B). In some embodiments, the protruding ridges of optical waveguides 20a may extend up into the gap 27, the shoulders 37 preventing or limiting contact with bottom surface 38. In some embodiments, the optics array 30d provides an optical pathway and mating connection between optical waveguides 20a and a unitary optical ferrule 50.

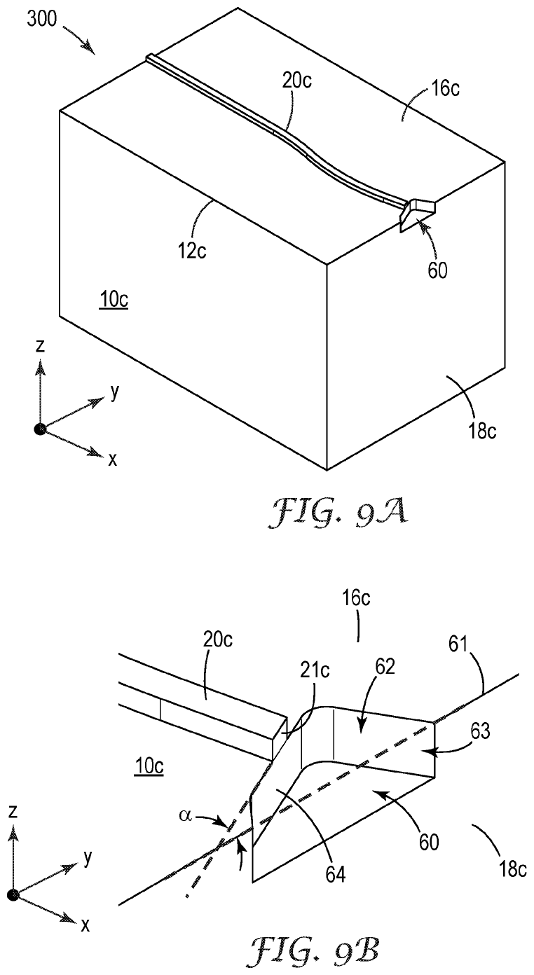

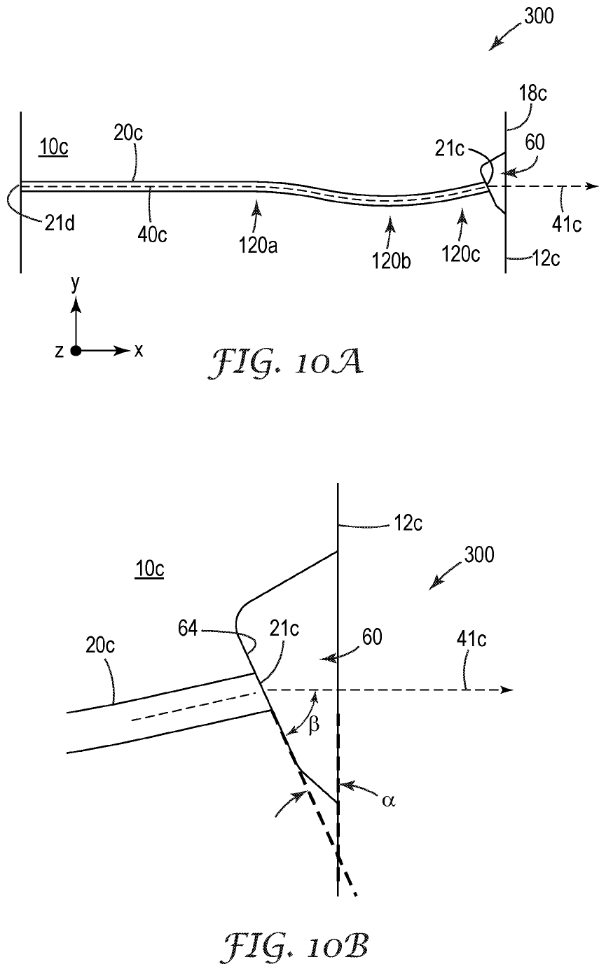

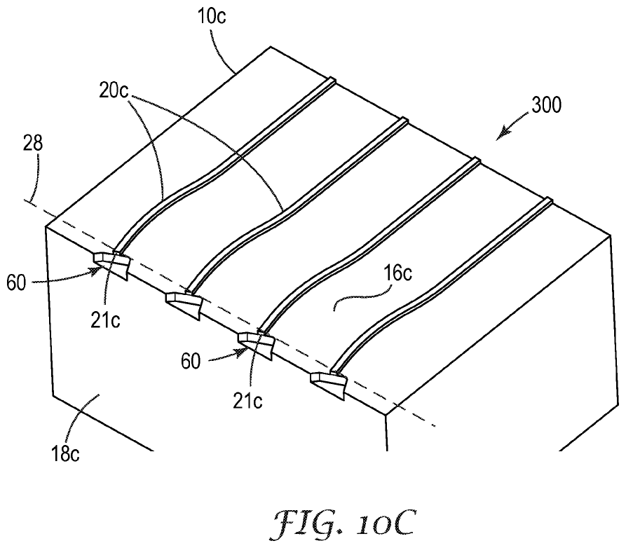

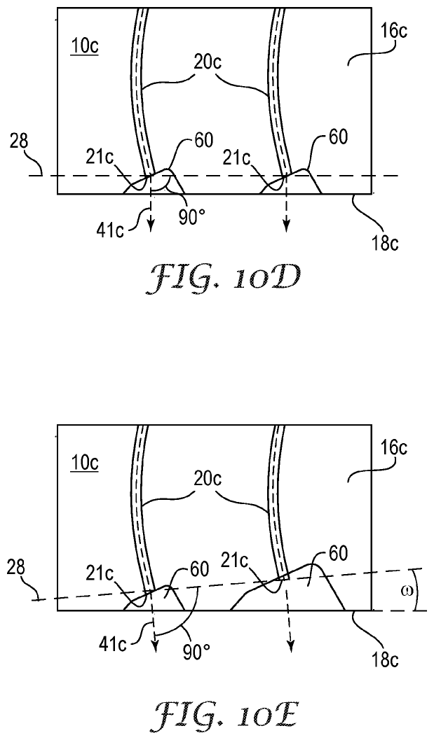

FIGS. 9A and 9B provide perspective views of an alternate embodiment of an angled optical waveguide embedded in a substate and terminating at a recess defined within the substrate, and FIGS. 10A and 10B provide top views of the same alternate embodiment of the angled optical waveguide. Turning first to FIGS. 9A and 9B, an optical assembly 300 includes a substrate 10c defining a recess or cutout 60 therein. In some embodiments, the recess 60 includes an open top 62 at the major top surface 16c of substrate 10c, an open side 63 at a minor side surface 18c, and a back wall 64 offset rearwardly from, and making an oblique angle a with, minor side surface 18c. In some embodiments, substrate 10c further includes one or more optical waveguides 20c disposed on and/or in substrate 10c. In some embodiments, each optical waveguide 20c has a first waveguide end 21c disposed at back wall 64.

Now turning to FIGS. 10A and 10B, providing top views of the optical waveguide 20c in optical assembly 300, it can be seen that, in some embodiments, optical waveguide 20c may include one or more bends 120a, 120b, 120c along a length of optical waveguide 20c between first waveguide end 21c and second waveguide end 21d. At each of these bends 120a, 120b, 120c (for example), the direction of propagation of a central light ray 40c may change. In some embodiments, when the central light ray 41c is emitted by optical waveguide 21, the direction of propagation of central light ray 41c may be substantially perpendicular to the minor side surface 18c (minor side surface 18c may be defined at an outermost perimeter 12c of substrate 10c). In some embodiments, central light ray 41c may be emitted by the optical waveguide 20c such that it propagates along a direction (e.g., the x-axis shown in FIG. 10A) making an oblique angle 13 with back wall 64 of recess 60.

FIGS. 10C-10E illustrate an embodiment of optical assembly 300 with multiple recesses 60 at the edge of substrate 10c opening to minor side surface 18c, and multiple optical waveguides 20c with first waveguide ends 21c terminating at the back wall of recesses 60. When multiple recesses 60 are present, and each of the multiple optical waveguides 20c terminates in a recess 60, the waveguide ends 21c may form a line 28 on the first major surface 16c. As shown in the top view of FIG. 10D, the direction of propagation of the central light ray 41c emitted by each optical waveguide 20c (emitted through waveguide end 21c) may be substantially perpendicular to line 28. In some embodiments, as shown in FIG. 10D, line 28 is substantially parallel to minor side surface 18c (and therefore, the direction of propagation of central light ray 41c emitted by optical waveguide 20c is also substantially perpendicular to minor side surface 18c. In other embodiments, such as the embodiment of FIG. 10E, line 28, defined by the positions of waveguide ends 21c, may be disposed at an oblique angle, w, relative to minor side surface 18c. In some embodiments, the direction of propagation of central light ray 41c emitted by optical waveguide 20c may remain substantially perpendicular to line 28, and therefore be at an oblique angle to minor side surface 18c.

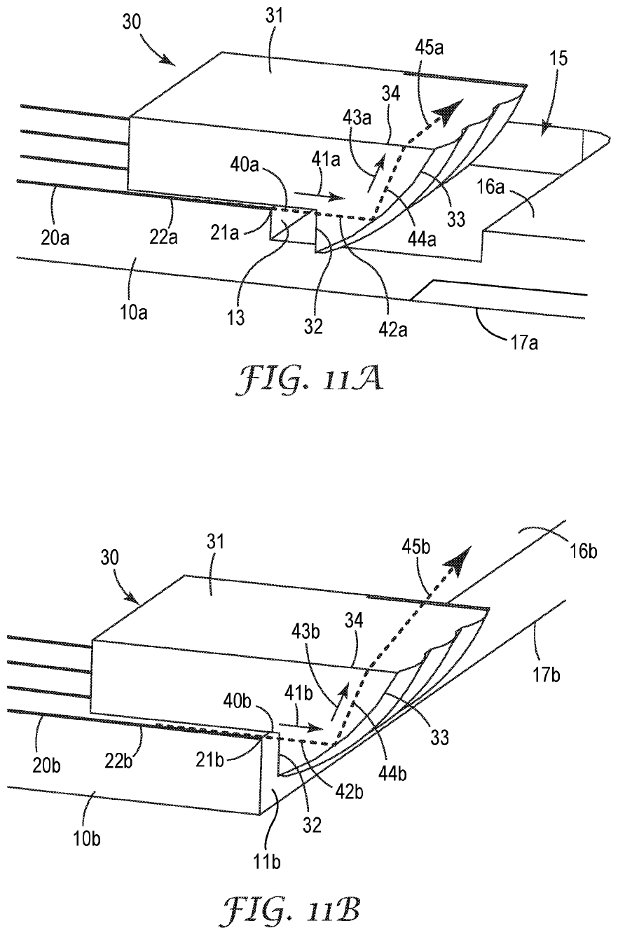

FIGS. 11A and 11B provide cutaway, perspective views of a unitary optics array 30 assembled to optical waveguides on a substrate. FIGS. 11A and 11B show similar embodiments. FIG. 11A shows how optics array 30 interfaces to waveguide ends 21a of optical waveguides 20a, when waveguide ends 21a are exposed on inner minor surface 13 of a recess 15 (e.g., a through-hole in substrate 10a connecting top major surface 16a and bottom major surface 17a). FIG. 11B shows how optics array 30 interfaces to waveguide ends 21b of optical waveguides 20b, when waveguide ends 21b are exposed at outmost minor surface 11b (e.g., the outer edge of the substrate 10b). The following discussion will apply to both FIGS. 11A and 11B unless specifically stated otherwise. In some embodiments, optics array 30 includes a support portion 31 (which may extend over a portion of top major surface 16a, 16b, including a portion 22a, 22b of optical waveguides 20a, 20b), an input surface 32, a redirecting surface 33, and an output surface 34. A central light ray 40a, 40b propagates through and is emitted from first waveguide ends 21a, 21b of optical waveguides 20a, 20b in a first direction 41a, 41b, entering optics array 30 at input surface 32. Light ray 40a, 40b continues traveling in first direction 41a, 41b until it is incident on redirecting surface 33, where it is redirected (e.g., reflected) into a second direction 43a, 43b as redirected central light ray 44a, 44b, until it exits optics array 30 at output location 34 as output central light ray 45a, 45b. In some embodiments, redirecting surface 33 may focus, or generally collimate, light ray 40a, 40b.

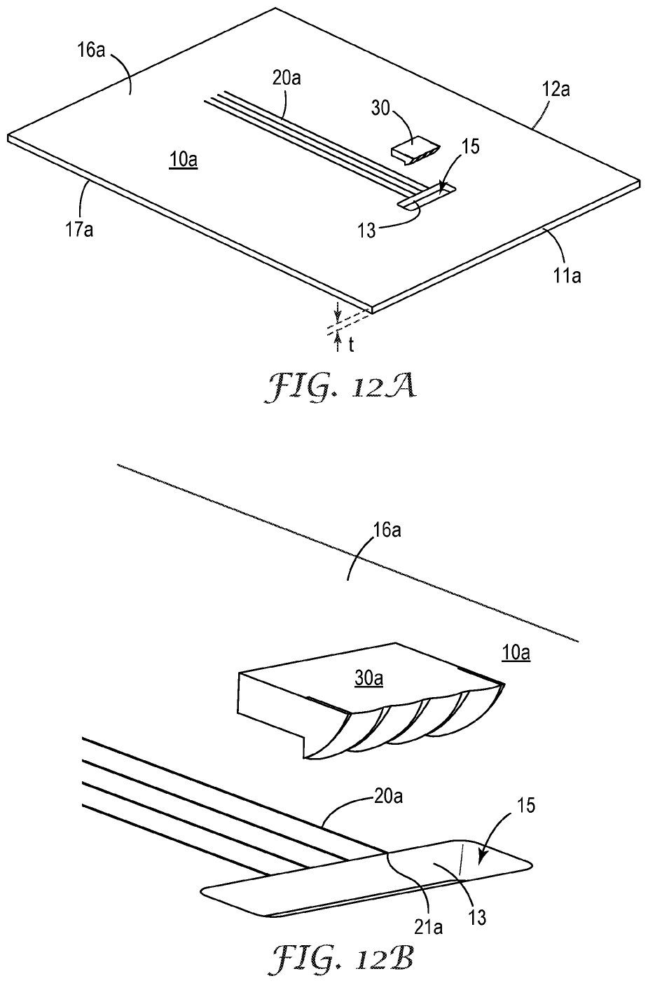

FIGS. 12A and 12B provide exploded perspective views of a unitary optics array interfacing to an optical waveguide within a recess within a substrate and should be reviewed together for the following discussion. A substrate 10a having a first major surface 16a and an opposing second major surface 17a and an outermost minor surface 11 a connecting the first 16a and second 17 major surfaces, may define a recess 15 having an innermost minor surface 13 (disposed within, and away from, outermost perimeter 12a). The substrate 10a may also include one or more optical waveguides 20a, and one or more of the optical waveguides 20a may have a waveguide end 21a disposed at innermost minor surface 13. In some embodiments, the recess 15 may be a through-recess extending across an entire thickness t of substrate 10a, connecting the first 16a and second 17a major surfaces. In other embodiments, recess 15 may only extend across a portion of the entire thickness t of substrate 10a (i.e., where recess 15 is a depression which does not extend down to major surface 17a). A unitary optics array 30 may, when in a mated position (not shown) extend down into recess 15 such that light emitted by waveguide ends 21a will enter optics array 30 as discussed elsewhere herein.

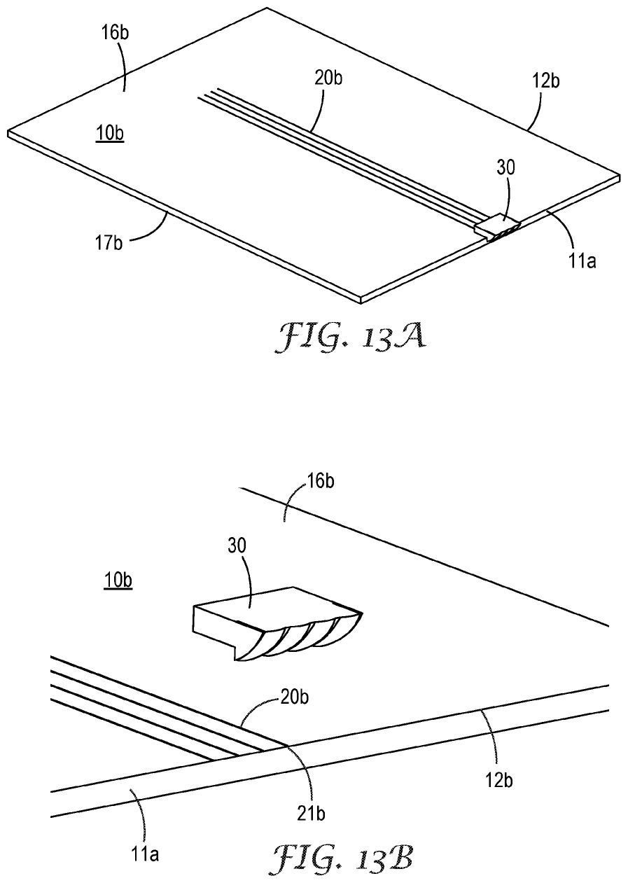

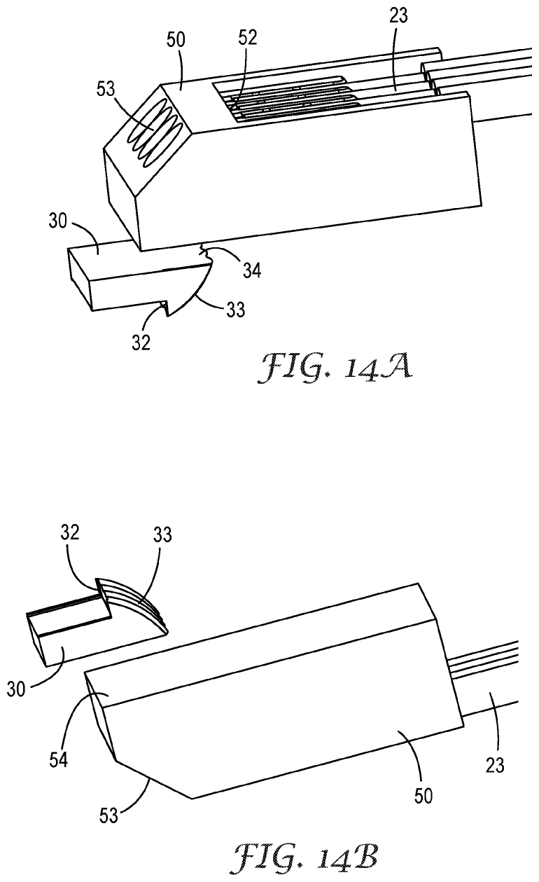

FIGS. 13A and 13B provide exploded perspective views of a unitary optics array interfacing to an optical waveguide terminating at an outer edge of a substrate and should be reviewed together for the following discussion. A substrate 10b includes a first major surface 16b and an opposing second major surface 17b and an outermost minor surface 11a connecting the first 16a and second 17 major surfaces and defining an outermost perimeter 12b of substrate 10b. Substrate 10b may also include one or more optical waveguides 20b, and one or more of the optical waveguides 20b may have a waveguide end 21b disposed at outermost minor surface 1 la (e.g., at the outer edge of substrate 10b). A unitary optics array 30 may, when in a mated position (as shown in FIG. 13A) extend down over outermost minor surface 11 a such that light emitted by waveguide ends 21b will enter optics array 30 as discussed elsewhere herein.

FIGS. 14A and 14B provide exploded perspective views of a unitary optics array interfacing to a unitary optical ferrule and should be reviewed together for the following discussion. In some embodiments, a unitary optical ferrule 50 may include an input surface 52, a redirecting surface 53, and an output surface 54. In some embodiments, the input surface 52 may include an anti-reflective coating Optical ferrule 50 is configured to receive a light ray from an optical waveguide 23, the light ray entering optical ferrule 50 through input surface 52. In some embodiments, optical ferrule 50 may be bonded to optical waveguide 23 with an index-matching optical adhesive. In some embodiments, a unitary optics array 30 may include an input surface 32, a redirecting surface 33, and an output surface 34. Optics array 30 is configured to receive a light ray from an optical waveguide on a substrate (see, for example, optical waveguides 20a, 20b in FIGS. 13A and 13B), the light ray entering optics array 30 through input surface 32.

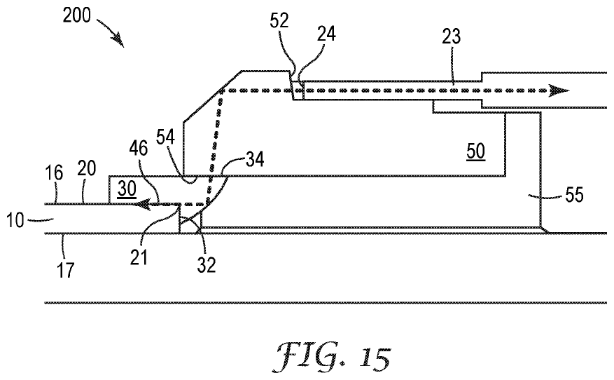

Finally, FIG. 15 provides a cutaway side view of the path of a central light ray through an optical assembly 200, including an optical ferrule 50 and an optics array 30. In some embodiments, optical ferrule 50 may be seated in and held in place (i.e., positioned such that optical ferrule 50 is properly mated to optics array 30) by an optical cradle 55. In some embodiments, the optics array 30 may be mounted to substrate 10, substrate 10 including opposing major surfaces 16 and 17 and including one or more optical waveguides 20. Light 46 may travel in either direction, from optics array 30 into mated optical ferrule 50, or from optical ferrule 50 into mated optics array 30. For example, light from optical waveguides 20, 23 may be emitted by a corresponding waveguide end 21, 24 and enter into an input surface 32, 52 and exiting at an output surface 34, 54 entering into the other component (i.e., either the optical ferrule 50 or optics array 30, depending on the direction of travel and origination point of light 46). The alignment and assembly of optical assembly 200 may be accomplished, for example, by first aligning the optics array 30 to the waveguides 20 and attaching it with optical adhesive to substrate 10. The optical ferrule with attached waveguides 23 may then be inserted into the optical cradle 55 and that subassembly may be actively aligned to the optics array 30 in order to maximize optical coupling between waveguides 20 and waveguides 23. Cradle 55 may then be attached to substrate 10 and/or recess/cutout 60 (see FIGS. 9A/9B) with adhesive.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An optical assembly comprising:
a substrate comprising a plurality of optical waveguides, each optical waveguide having a first waveguide end; and
a unitary optics array assembled to the substrate and comprising:
a support portion attached to the substrate and covering at least a portion of a major top surface of the substrate;
an input surface facing the first waveguide end of each optical waveguide;
a redirecting surface; and
an output surface, such that for each optical waveguide in the plurality of optical waveguides, the input surface is configured to receive and transmit a central light ray propagating through and emitted from the first waveguide end of the optical waveguide, and the redirecting surface is configured to receive the central light ray transmitted by the input surface along a first direction and redirect the received central light ray along a second direction different from the first direction, the redirected central light ray exiting the optics array as an output central light ray through the output surface.

2. The optical assembly of claim 1, wherein the support portion covers at least a portion of at least one optical waveguide in the plurality of optical waveguides.

3. The optical assembly of claim 1, wherein the support portion covers at least a portion of each optical waveguide in the plurality of optical waveguides.

4. The optical assembly of claim 1, wherein the portion of the major top surface of the substrate covered by the support portion of the optics array is on a lateral side of the plurality of optical waveguides.

5. The optical assembly of claim 1, wherein the support portion leaves the optical waveguides in the plurality of optical waveguides uncovered.

6. The optical assembly of claim 1, wherein at least one of the optical waveguides in the plurality of optical waveguides is a ridge waveguide protruding from the major top surface of the substrate, and wherein the support portion of the optics array comprises at least one groove receiving at least a portion of the at least one of the optical waveguides therein.

7. The optical assembly of claim 1, wherein the substrate comprises a minor surface extending from a major surface of the substrate along a thickness direction of the substrate, and wherein the first waveguide ends of the optical waveguides are offset rearwardly from the minor surface along lengths of the optical waveguides.

8. The optical assembly of claim 1, wherein the substrate comprises a minor surface extending from a major surface of the substrate along a thickness direction of the substrate, wherein the optics array comprises a stop surface disposed proximate and facing the minor surface of the substrate, and wherein the stop and input surfaces of the optics array are offset relative to each other along lengths of the optical waveguides.

9. The optical assembly of claim 8, wherein the offset between the stop and input surfaces of the optics array defines a shoulder portion of the optics array, and wherein the minor surface of the substrates defines a cutout therein receiving and supporting the shoulder portion of the optics array.

10. The optical assembly of claim 8, wherein the first waveguide ends of the optical waveguides and the input surface of the optics array define a reservoir therebetween configured to be substantially filled with an optical material.

11. The optical assembly of claim 1, wherein the support portion and the major top surface of the substrate covered by the support portion define a gap therebetween that extends laterally across the optical waveguides in the plurality of optical waveguides.

12. The optical assembly of claim 1, wherein the support portion comprises a pair of opposing shoulders extending from a bottom surface of the support portion, the shoulders defining a recessed portion therebetween, each shoulder resting on the major top surface of the substrate on a corresponding lateral side of the plurality of the waveguides.

13. The optical assembly of claim 1, wherein the substrate comprises:
opposing first and second major surfaces and an outermost minor surface connecting the first and second major surfaces and defining an outermost perimeter of the substrate; and
an inner minor surface disposed within, and away from, the outermost perimeter, wherein the first waveguide end of each optical waveguide is disposed at the inner minor surface.

14. The optical assembly of claim 13, wherein the substrate defines a recess in the first major surface, the recess comprising the inner minor surface, and wherein at least a portion of the input surface of the optics array is disposed within the recess proximate to, and facing, the first waveguide end and the inner minor surface.

15. The optical assembly of claim 14, wherein the recess is a through recess extending across an entire thickness of the substrate and connecting the first and second major surfaces.

16. The optical assembly of claim 13, wherein the inner minor surface and the input surface of the optics array are substantially parallel to each other.

17. The optical assembly of claim 1, wherein the substrate comprises opposing first and second major surfaces and an outermost minor surface connecting the first and second major surfaces and defining an outermost perimeter of the substrate, wherein the first waveguide end of each optical waveguide is disposed at the outermost minor surface, and wherein at least a portion of the input surface of the optics array is disposed proximate to, and facing, the first waveguide end and the outermost minor surface.

18. The optical assembly of claim 1, wherein the substrate comprises a minor side surface extending downwardly from a first edge of the major top surface of the substrate along a thickness direction of the substrate, the substrate defining a cutout at the first edge, the cutout having an open top at the major top surface, an open side at the minor side surface, and a back wall offset rearwardly from, and making an oblique angle with, the minor surface, wherein the first waveguide end of at least one optical waveguide in the plurality of optical waveguides is disposed at the back wall of the cutout.

19. The optical assembly of claim 23, wherein the at least one optical waveguide comprises at least one bend that changes a direction of propagation of central light ray propagating in and along the at least one optical waveguide.

20. The optical assembly of claim 23, wherein a central light ray emitted by the at least one optical waveguide propagates along a direction substantially perpendicular to the minor side surface of the substrate.
